(19) United States
(12) Patent Application Publication
(10) Pub. No.: US 2017/0066310 A1
(43) Pub. Date: Mar. 9, 2017

(54) Method of Bonding Tarpaulin And Tarpaulin Manufactured Thereby

(71) Applicant: G&E Biopolytex Co., Ltd., Seoul (KR)

(72) Inventor: Do-Jin Chung, Seoul (KR)

(21) Appl. No.: 14/846,126

(22) Filed: Sep. 4, 2015

(51) Int. Cl. B60J 7/10; B29C 65/00; B29C 65/10

(52) U.S. Cl. CPC B60J 7/10; B29C 65/103; B29C 66/435; B29C 66/12221; B29L 2007/005

(57) ABSTRACT

The present invention is related to a method of bonding tarpaulin and tarpaulin manufactured thereby. More specifically, the present invention is characterized in that the engaging area formed by overlapping the first and second tarpaulin fabrics each other is weld-bonded by means of hot air blowing from the first L-shaped nozzle, and the tarpaulin band is weld-bonded along the upper part of said weld-bonded engaging area by means of hot air blowing from the second L-shaped nozzles, wherein said tarpaulin band is melted in its underside by means of hot air from the second L-shaped nozzles and is weld-bonded to the first and second tarpaulin fabrics to entirely cover the engaging area with a sufficient establishment of a widthwise size. Thus, a better strength is provided in the engaging area and the tarpaulin fabric is improved in its robustness, durability and marketability.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention is related to a method of bonding tarpaulin, wherein first and second tarpaulin fabrics are weld-bonded along their engaging area in which the first and second tarpaulin fabrics overlap each other and wherein a tarpaulin band is weld-bonded along an upper part of said engaging area, while the tarpaulin band entirely covers the engaging area of the first and second tarpaulin fabrics. Accordingly, the weld-bonded engaging area has an excellent strength. The present invention is also related to a tarpaulin manufactured by the method of the present invention.

Generally, tarpaulin fabric is widely and increasingly used for a waterproof tent, a pavilion, a cover for transportation means, a visual sculpture of large arena and leisure installation, etc.

The tarpaulin fabric may be classified into PVC tarpaulin and PE tarpaulin depending on material feature. The PVC tarpaulin is manufactured by coating PVC on either side of PET fabric comprising multifilament film yarn, whereas the PE tarpaulin is manufactured by coating low density polyethylene (LDPE) on either side of high density polyethylene (HDPE) film.

Depending on a usage type, the tarpaulin fabric may be used by bonding original fabrics each other.

Conventionally, first and second tarpaulin fabrics are arranged to overlap each other and then an overlapping area of the first and second tarpaulin fabrics is melted by hot air to thereby obtain weld-bonding in the overlapping area, so that the first and second fabrics are used in a bonded state.

However, the conventional method of bonding tarpaulin fabrics as described above has the problem of decrease in bonding strength due to a smaller bonding area between the first and second tarpaulin fabrics, since the first and second tarpaulin fabrics are weld-bonded only in their overlapping area.

In other words, the bonding area between the first and second tarpaulin fabrics is small to thereby degrade the bonding strength, which leads to loss of rigidity and durability in the bonding area of tarpaulin fabrics. Therefore, there is the problem of deteriorating merchantable quality of tarpaulin fabric.

### BRIEF SUMMARY

The present invention is to solve the above-described problems of the conventional method. The object of the present invention is to provide a method of bonding tarpaulin, wherein first and second tarpaulin fabrics are weld-bonded with their engaging area overlapping each other; and wherein a tarpaulin band is weld-bonded along an upper portion of said weld-bonded area, while said tarpaulin band is weld-bonded so as to entirely cover the weld-bonded area of the first and second tarpaulin fabrics, to thereby reinforce the weld-bonded area.

According to the present invention, the method of bonding tarpaulin comprises: a process of bonding tarpaulin fabrics, wherein an engaging area, in which first and second tarpaulin fabrics overlap each other, is weld-bonded by means of hot air blowing from a first L-shaped nozzle; a process of providing a tarpaulin band, wherein a strip type-tarpaulin band is provided along an upper portion of said engaging area of the first and second tarpaulin fabrics that was weld-bonded; a process of melting tarpaulin band, wherein an underside of said tarpaulin band is melted by means of hot air blowing from a pair of second L-shaped nozzles positioned at either side of said tarpaulin band; and a process of bonding tarpaulin band, wherein said tarpaulin band is weld-bonded to said engaging area for allowing said tarpaulin band to cover said engaging area between the first and second tarpaulin fabrics to thereby reinforce said engaging area.

In the present invention, the engaging area formed by overlapping the first and second tarpaulin fabrics each other is weld-bonded by means of hot air blowing from the first L-shaped nozzle, and the tarpaulin band is weld-bonded along the upper part of said weld-bonded engaging area by means of hot air blowing from the second L-shaped nozzles, wherein said tarpaulin band is melted in its underside by means of hot air from the second L-shaped nozzles and is weld-bonded to the first and second tarpaulin fabrics to entirely cover the engaging area with a sufficient establishment of a widthwise size. Thus, a better strength is provided in the engaging area and the tarpaulin fabric is improved in its robustness, durability and marketability.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a view of manufacturing processes according to the present invention.

FIG. 2 is a schematic front view showing a process of weld-bonding first and second tarpaulin fabrics by means of first L-shaped nozzle according to the present invention.

FIG. 3 is a schematic planar view showing the first and second tarpaulin fabrics that was weld-bonded.

FIG. 4 is a schematic front view showing a weld-bonding process of the tarpaulin band by means of second L-shaped nozzles.

FIG. 5 is a front view showing the weld-bonded fabrics of FIG. 4.

FIG. 6 is an enlargement view of “A” in FIG. 5.

FIG. 7 is a plane view of FIG. 5.

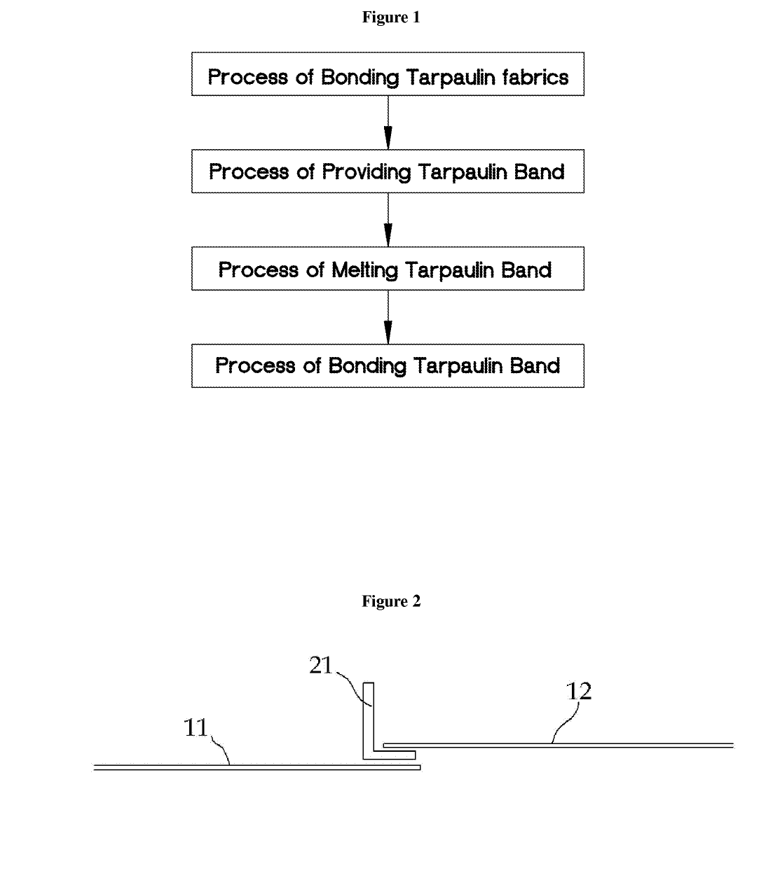

### DETAILED DESCRIPTION

First of all, a method of bonding tarpaulin of the present invention will be described.

According to the present invention, a method of bonding tarpaulin comprises: a process of bonding tarpaulin fabrics, wherein an engaging area, in which first and second tarpaulin fabrics overlap each other, is weld-bonded by means of hot air blowing from a first L-shaped nozzle; a process of providing a tarpaulin band, wherein a strip type-tarpaulin band is provided along an upper portion of said engaging area of the first and second tarpaulin fabrics that was weld-bonded; a process of melting tarpaulin band, wherein an underside of said tarpaulin band is melted by means of hot air blowing from a pair of second L-shaped nozzles positioned at either side of said tarpaulin band; and a process of bonding tarpaulin band, wherein said tarpaulin band is weld-bonded to said engaging area for allowing said tarpaulin band to cover said engaging area of the first and second tarpaulin fabrics to thereby reinforce said engaging area.

Here, said tarpaulin band further extends in right- and left widthwise directions beyond edges of said overlapping and engaging area of said first and said second tarpaulin fabrics to thereby cover and bond said first tarpaulin fabric, said engaging area between said first and second tarpaulin fabrics and said first tarpaulin fabric.

Herein-below, an embodiment of the present invention will be described with reference to the drawings.

1. Process of Bonding Tarpaulin Fabrics

While first and second tarpaulin fabrics (11, 12) are conveyed with their engaging area (13) overlapping each other, hot air blowing from a first L-shaped nozzle (21) melts said engaging area (13) to thereby weld-bond said engaging area.

Preferably, the engaging area (13) of the first and second tarpaulin fabrics (11, 12) has a length ranging from 4 to 5 centimeter.

If the engaging area (13) of the first and second tarpaulin fabrics (11, 12) is less than 4 centimeter in its length, it is impossible to obtain suitable strength in the engaging area (13). If the engaging area (13) is greater than 5 centimeter in its length, it is impossible to effectively melt the engaging area (13) by means of hot air blowing from the L-shaped nozzle (21), which leads to unfavorable performance in weld-bonding operation of the fabrics.

2. Process of Providing Tarpaulin Band

After weld-bonding operation between the first and second tarpaulin fabrics (11, 12) with their engaging area overlapping each other, a tarpaulin band (30) is provided over the engaging area (13) along its lengthwise direction.

3. Process of Melting Tarpaulin Band

A bonding face of the tarpaulin band is melted by means of hot air blowing from second L-shaped nozzles (22, 22), which are respectively positioned under the tarpaulin band at either side.

In order to make the tarpaulin band (30) to cover and bond the engaging area (13) of first and second tarpaulin fabrics, the tarpaulin band (30) is configured to have an entire width ranging from 12 to 14 centimeter, which corresponds to a width of between 6 and 7 centimeter from a middle of the engaging area (13) to an edge thereof. Accordingly, a pair of L-shaped nozzles located at either side is needed to melt the underside of the tarpaulin band, instead of adopting a single L-shaped nozzle.

Here, if the tarpaulin band (30) is greater than 14 centimeter in its width, it is impossible to effectively melt the bonding face of the tarpaulin band by means of hot air blowing from the second L-shaped nozzles at either side, which leads to ineffective performance of weld-bonding. If the tarpaulin band (30) is less than 12 centimeter in its width, it is very inconvenient to bond the entire engaging area (13) of the first and second tarpaulin fabrics. Accordingly, it is preferable for the tarpaulin band to have the width ranging from 12 to 14 centimeter, which can sufficiently melt the bonding face of the tarpaulin band using the second L-shaped nozzles.

4. Process of Bonding Tarpaulin Band

While the tarpaulin band (30) covers the engaging area (13) of the first and second tarpaulin fabrics, the tarpaulin band (30) is weld-bonded to the engaging area (13).

Specifically, the tarpaulin band (30) extends in right and left directions farther than the width of the engaging area (13) in which the first and second tarpaulin fabrics (11, 12) overlap each other, so that it covers the first tarpaulin fabric (11), the engaging area (13) of the first and second tarpaulin fabrics (11, 12) and the second tarpaulin fabric (12).

In other words, since the engaging area (13), in which the first and second tarpaulin fabrics (11, 12) overlap each other, has the width of between 4 and 5 centimeter, and the tarpaulin band (30) has the width of between 12 and 14 centimeter corresponding to the widths of between 6 and 7 centimeter from the middle of the tarpaulin band to its edge, the tarpaulin band (30) covers portions of the first and second tarpaulin fabrics adjacent to the engaging area as well as the engaging area (13) in which the first and second tarpaulin fabrics (11, 12) overlap each other.

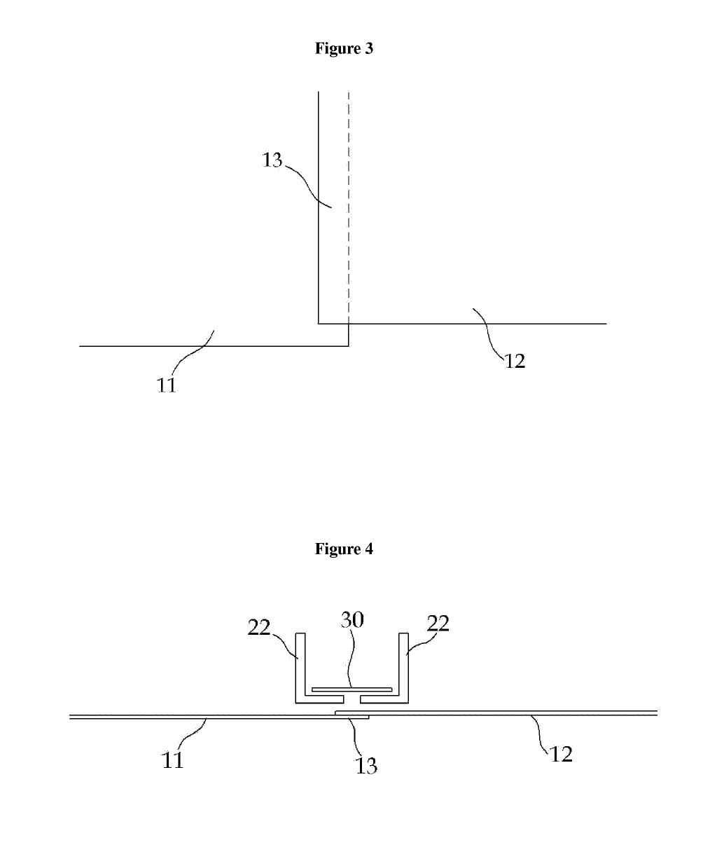

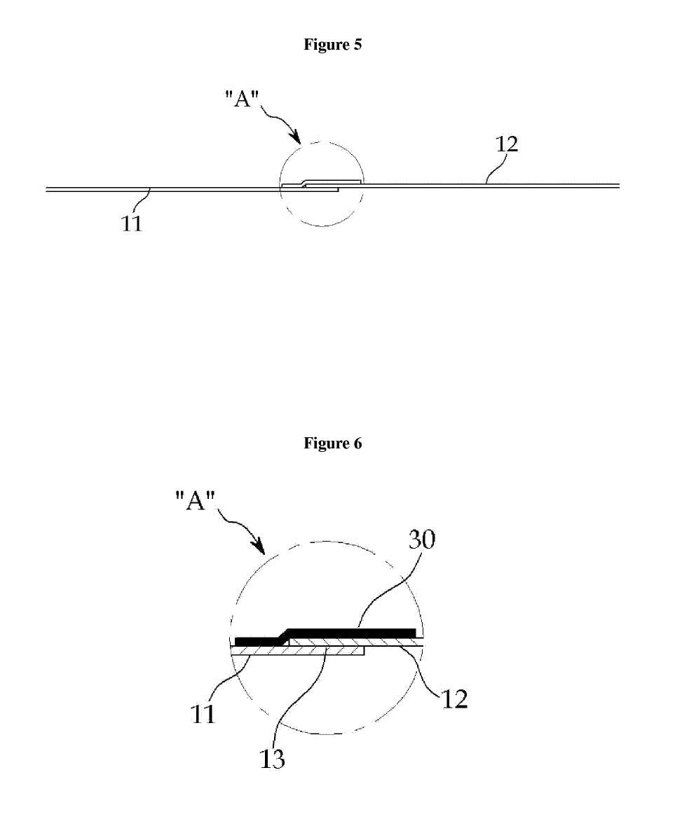

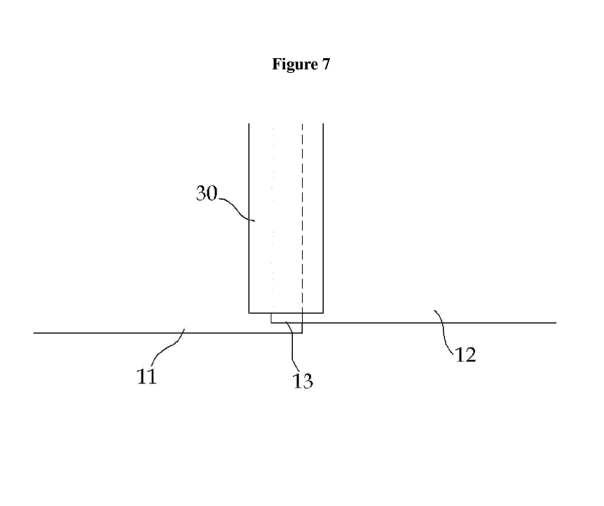

A tarpaulin of the present invention is manufactured by the method according to the present invention as shown in FIGS. 2 to 7, wherein the engaging area (13) in which the first and second tarpaulin fabrics (11, 12) overlap each other is weld-bonded by means of hot air blowing from the first L-shaped nozzle (21); the tarpaulin band (30) is provided along the upper portion of the engaging area (13) of the first and second tarpaulin fabrics; a lower side of the tarpaulin band (30) is melted by means of hot air blowing from the second L-shaped nozzles (22, 22) positioned at either side under the tarpaulin band (30); and the tarpaulin band (30) is weld-bonded to the first and second tarpaulin fabrics (111, 12) to cover the engaging area (13), so that the engaging area is reinforced.

Here, the engaging area (13) in which the first and second tarpaulin fabrics (11, 12) overlap each other has the width of between 4 and 5 centimeter. The tarpaulin band (30) has the width of between 12 and 14 centimeter, which corresponds to the width of between 6 and 7 centimeter from the middle of the tarpaulin band to its edge.

In the present invention, the engaging area (13) in which the first and second fabrics (11, 12) overlap each other is melted by means of hot air blowing from the first L-shaped nozzle (21) and is weld-bonded each other; and the tarpaulin band (30) is weld-bonded by means of hot air blowing from the second L-shaped nozzles (22,22) along the engaging area (13) of the first and second tarpaulin fabrics (11, 12), wherein the engaging area (13) in which the first and second tarpaulin fabrics (11, 12) overlap each other has the width of between 4 and 5 centimeter, and wherein the tarpaulin band (30) weld-bonded onto the engaging area (13) has the width of between 12 and 14 centimeter, which corresponds to the width of between 6 and 7 centimeter from the middle of the tarpaulin band to its edge. Accordingly, the tarpaulin band (30) is weld-bonded to the engaging area (30) of the first and second tarpaulin fabrics to entirely cover the same, so that the strength of the engaging area is reinforced.

What is claimed is:

1. A method of bonding tarpaulin fabric, comprising steps of:
weld-bonding an engaging area, in which first and second tarpaulin fabrics overlap each other, by means of hot air blowing from a first L-shaped nozzle;
providing a strip type-tarpaulin band above said engaging area of the first and second tarpaulin fabrics that was weld-bonded;
melting an underside of said tarpaulin band by means of hot air blowing from a pair of second L-shaped nozzles positioned at either side of said tarpaulin band; and
weld-bonding said tarpaulin band to said engaging area for allowing said tarpaulin band to cover said engaging area of the first and second tarpaulin fabrics to thereby reinforce said engaging area.

2. The method of bonding tarpaulin fabric as claimed in claim 1, characterized in that said tarpaulin band further extends in right- and left widthwise-directions beyond edges of said overlapping engaging area of said first and said second tarpaulin fabrics to thereby cover and bond said first tarpaulin fabric, said engaging area of said first and second tarpaulin fabrics and said first tarpaulin fabric.

3. Tarpaulin manufactured by the method of claim 1, wherein the engaging area, in which the first and second tarpaulin fabrics overlap each other, is weld-bonded by means of hot air blowing from a first L-shaped nozzle, wherein the strip-type band is provided above the engaging area of the first and second tarpaulin fabrics that was weld-bonded, wherein the underside of the tarpaulin band is melted by means of two L-shaped nozzles positioned at either side of the tarpaulin band, and wherein the tarpaulin band is weld-bonded for covering said engaging area of the first and second tarpaulin fabrics, to thereby reinforce the engaging area.

4. The tarpaulin as claimed in claim 1, characterized in that
said tarpaulin band extends in right- and left-directions farther than a widthwise length of said engaging area in which the first and second fabrics overlap each other, to thereby cover and bond said first tarpaulin fabric, said engaging area of said first and second tarpaulin fabrics and said first tarpaulin fabric.

5. The tarpaulin as claimed in claim 3, characterized in that said engaging area, in which the first and second tarpaulin fabrics overlap each other, has a width ranging from 4 to 5 centimeter and said tarpaulin band has an entire width ranging from 12 to 14 centimeter, which corresponds to a width of between 6 and 7 centimeter from a middle of the tarpaulin band to its edge.

6. The tarpaulin as claimed in claim 4, characterized in that said engaging area, in which the first and second tarpaulin fabrics overlap each other, has a width ranging from 4 to 5 centimeter and said tarpaulin band has an entire width ranging from 12 to 14 centimeter, which corresponds to a width of between 6 and 7 centimeter from a middle of the tarpaulin band to its edge.
